(19) United States
(12) Patent Application Publication
(10) Pub. No.: US 2023/0359182 A1
(43) Pub. Date: Nov. 9, 2023

(54) WORK MANAGEMENT APPARATUS

(71) Applicant: HITACHI, LTD., Tokyo (JP)

(72) Inventors: Koji Yamasaki, Tokyo (JP); Chiyo Ohno, Tokyo (JP); Akinobu Watanabe, Tokyo (JP)

(73) Assignee: HITACHI, LTD., Tokyo (JP)

(21) Appl. No.: 18/299,782

(22) Filed: Apr. 13, 2023

(30) Foreign Application Priority Data
May 9, 2022 (JP) 2022-076929

(51) Int. Cl. G05B 19/418

(52) U.S. Cl. CPC G05B 19/41875; G05B 2219/32366

(57) ABSTRACT

Provided is a work management apparatus that is capable of allowing actual work to be continued without stopping a system as a whole even in the case where work start and completion times are lost. The work management apparatus according to the present invention recognizes content of work of a worker on the basis of a recognition result of a motion of the worker and a recognition result of an operation status of an object used by the worker and identifies a start time and a completion time according to the content of the work, to thereby confirm whether or not there is any missing content of the work.

### BACKGROUND OF THE INVENTION

### 1. Field of the Invention

The present invention relates to a technology for managing work to be performed by a worker.

### 2. Description of the Related Art

On a production line, manufacturing processes are performed on the basis of a production plan created in advance. In order to grasp whether or not the manufacturing processes are progressing as planned, it is desirable that a difference between the plan and actual performance can be checked with high accuracy by acquiring an actual work time period. As for production processes that are automated or semi-automated by robots and facilities, it is possible to collect, for one or more pieces of work included in the processes, beginning and end times of each and detect a delay from the plan.

Japanese Patent Laid-Open No. 2021-189607 describes a technology whose object is to “confirm a progress of manufacturing processes reliably while at the same time reducing workers' labor” and in which “a process management apparatus (100) includes a detection section (151) for detecting entry of a target to be processed into a predetermined bound in the vicinity of a facility that performs the processes and a start/completion judgment section (11) that sets, as a start time, a time when the entry of the target to be processed into the predetermined bound is detected or a time after the elapse of a predetermined time period from the time in question” (refer to ABSTRACT OF THE DISCLOSURE).

### SUMMARY OF THE INVENTION

Detection results of a time when a worker starts work (start time) and completes work (completion time) are reported to a superordinate system, for example, a manufacturing execution system (MES). It should be noted, however, that the start time and the completion time cannot not always be detected and that there are cases where information regarding these times is lost for various reasons. If a report is made to the superordinate system with these times lost, there is a possibility that the superordinate system may determine that an error has occurred in the manufacturing processes and stop the manufacturing processes. A similar problem can occur in work systems other than the manufacturing processes.

The present invention has been made in view of the problem as described above, and it is an object thereof to provide a work management apparatus that is capable of allowing actual work to be continued without stopping a system as a whole even in the case where work start and completion times are lost.

A work management apparatus according to the present invention recognizes content of work of a worker on the basis of a recognition result of a motion of the worker and a recognition result of an operation status of an object used by the worker and identifies a start time and a completion time according to the content of the work, to thereby confirm whether or not there is any missing content of the work.

### Advantageous Effect of Invention

According to the work management apparatus according to the present invention, it is possible to continue actual work without stopping a system as a whole by confirming whether or not there is any missing content of work even in the case where work start and completion times are lost.

### BRIEF DESCRIPTION OF THE DRAWINGS

FIG. 1 is a configuration diagram of a work management system according to embodiment 1;

FIG. 2 is a sequence chart describing operation of the work management system as a whole;

FIG. 3 illustrates an example of a work instruction received by a work management apparatus in S204;

FIG. 4 is a flowchart describing a procedure for a control section to send a sensor switching instruction;

FIG. 5 is a flowchart describing a procedure for the control section to determine a sensor to be used for monitoring work;

FIG. 6 is an example of past performance acquired in S501;

FIG. 7 is a flowchart describing a procedure until a start/completion judgment section extracts start and completion times;

FIG. 8 is a flowchart describing details of S710;

FIG. 9 is an example of start/completion information output by the start/completion judgment section in S208;

FIG. 10 is a configuration diagram of a work management system according to embodiment 2;

FIG. 11 illustrates a configuration of a model table and examples of data;

FIG. 12 is a flowchart describing a procedure for the control section to switch between recognition models;

FIG. 13 illustrates examples of work items whose start and completion times are lost;

FIG. 14 is a flowchart describing a procedure for the start/completion judgment section to complement the start and completion times; and

FIG. 15 is an example of the start/completion information in which the start and completion times have been complemented.

### DESCRIPTION OF THE PREFERRED EMBODIMENTS

### Embodiment 1

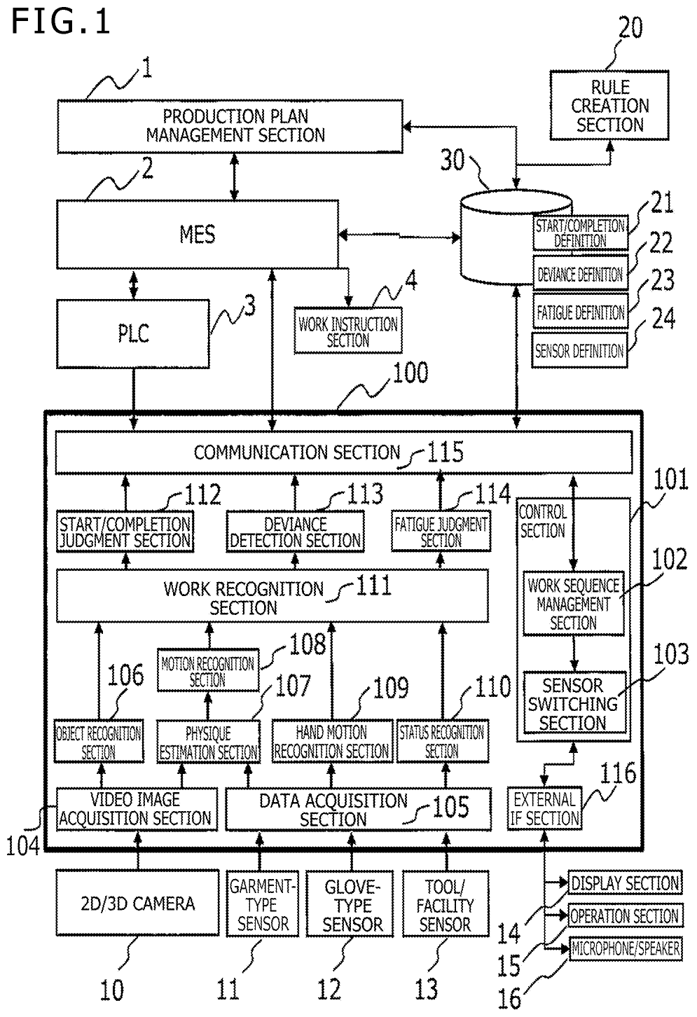

FIG. 1 is a configuration diagram of a work management system according to embodiment 1 of the present invention. A production plan management section 1 manages a production plan as a whole in manufacturing processes. A manufacturing execution system (MES) 2 manages work processes via a work management apparatus 100 and further outputs an instruction regarding content of work (work instruction) to a work instruction section 4. A programmable logic controller (PLC) 3 controls work machinery. The work instruction section 4 presents a work instruction to a worker, for example, by screen display. A rule creation section 20 creates management rules for a production plan used by the production plan management section 1 and stores them in a storage section 30. The storage section 30 stores, in addition thereto, a start/completion definition 21, a deviance definition 22, a fatigue definition 23, and a sensor definition 24. These definitions will be described later.

A 2D/3D camera 10, a garment-type sensor 11, a glove-type sensor 12, and a tool/facility sensor 13 are connected to the work management apparatus 100. The 2D/3D camera 10 is a sensor that monitors a manner in which a worker works. The garment-type sensor 11 and the glove-type sensor 12 are types of sensors to be worn by the worker. The tool/facility sensor 13 is a sensor that is included in a tool or facility used by the worker. These sensors are for detecting content of work performed by the worker.

A display section 14, an operation section 15, and a microphone/speaker 16 are further connected to the work management apparatus 100. The display section 14 is an interface that displays results of processing performed by the work management apparatus 100. The operation section 15 is an operation interface for a user to give instructions to the work management apparatus 100. The microphone/speaker 16 is an audio interface. As for the display section 14, the operation section 15, and the microphone/speaker 16, the same devices as those of the work instruction section 4 may be used.

The work management apparatus 100 includes a control section 101, a work sequence management section 102, a sensor switching section 103, a video image acquisition section 104, a data acquisition section 105, an object recognition section 106, a physique estimation section 107, a motion recognition section 108, a hand motion recognition section 109, a status recognition section 110, a work recognition section 111, a start/completion judgment section 112, a deviance detection section 113, a fatigue judgment section 114, a communication section 115, and an external IF section 116.

The video image acquisition section 104 acquires video image data captured by the 2D/3D camera 10. The object recognition section 106 acquires video image data from the video image acquisition section 104 and recognizes an object used by the worker (e.g., target to be worked on) by using the video image data. The physique estimation section 107 acquires video image data from the video image acquisition section 104 and estimates a worker's physique (and a posture based on the physique) by using the video image data. The motion recognition section 108 recognizes a motion (e.g., assembly motion) being performed by the worker, by using the estimation result.

The data acquisition section 105 acquires a detection result from each of the garment-type sensor 11, the glove-type sensor 12, and the tool/facility sensor 13. The hand motion recognition section 109 recognizes a hand motion of the worker by using the detection results. The status recognition section 110 recognizes the status (e.g., in use, or powered off) of the tool or facility by using the detection results.

The work recognition section 111 recognizes the content of work of the worker by using respective recognition results of the object recognition section 106, the motion recognition section 108, the hand motion recognition section 109, and the status recognition section 110. For example, it is possible, by recognizing the tool used by the worker with the object recognition section 106, to recognize that the worker is performing work using the tool. It should be noted, however, that there is a possibility of erroneous recognition or that there is a possibility that accuracy for recognizing the content of work is not always high due to existence of a plurality of types of work using the tool or the like. Therefore, the work recognition section 111 enhances the recognition accuracy by synthesizing the recognition results of the plurality of recognition sections. For example, it is possible to enhance or correct the accuracy for recognizing the content of work, by recognizing the content of work using the tool with the motion recognition section 108 and the hand motion recognition section 109. Further, it is possible to enhance the recognition accuracy through the use of the tool status in a superimposed manner, by recognizing the tool status with the status recognition section 110.

The start/completion judgment section 112 identifies a start time and a completion time of a piece of work from the content of work recognized by the work recognition section 111. A definition as to whether or not each of start and completion applies is prescribed by the start/completion definition 21. The deviance detection section 113 judges whether or not the content of work recognized by the work recognition section 111 departs from the work instruction from the work instruction section 4. A definition as to whether or not deviance applies is prescribed by the deviance definition 22. The fatigue judgment section 114 judges, on the basis of the content of work recognized by the work recognition section 111, whether or not the worker is fatigued from the worker's posture, motion size, and the like with the physique estimation section 107 and the motion recognition section 108. A definition as to whether or not fatigue applies is prescribed by the fatigue definition 23. The sensor definition 24 is data used when the detection result of each sensor is processed.

The control section 101 controls the respective sections included in the work management apparatus 100. The work sequence management section 102 manages the work sequence performed by the worker. The sensor switching section 103 switches between sensors to be used for recognizing the content of work of the worker, by means of a procedure described later. The external IF section 116 is an interface with the display section 14, the operation section 15, and the microphone/speaker 16. The communication section 115 communicates with external apparatuses. For example, the communication section 115 receives a work instruction from the MES 2 and sends a start/completion report which will be described later to the MES 2.

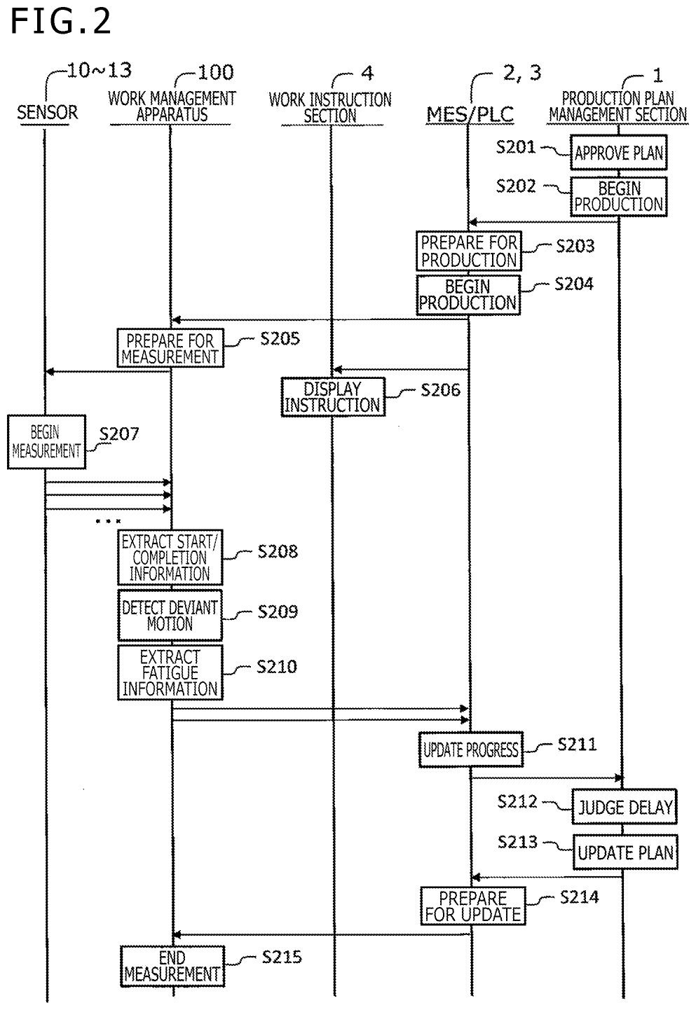

FIG. 2 is a sequence chart describing operation of the work management system as a whole. After approving a production plan (S201), the production plan management section 1 instructs the MES 2 and the PLC 3 to begin the production (S202). When the preparation for production is completed (S203), the MES 2 and the PLC 3 begin production processes (S204) and notify the work management apparatus 100 to that effect together with a work instruction. The MES 2 and the PLC 3 notify the content of work to the work instruction section 4, and the work instruction section 4 presents that instruction to the worker (S206).

The work management apparatus 100 instructs the respective sensors 10 to 13 to prepare for measurement (S205), and the respective sensors 10 to 13 begin the measurement (S207). The work management apparatus 100 acquires a detection result from each sensor. The start/completion judgment section 112 extracts a start time and a completion time from the sensor detection results (S208), the deviance detection section 113 detects a deviance in work from the sensor detection results (S209), and the fatigue judgment section 114 extracts whether or not the worker is fatigued (S210). These detection results are notified to the MES 2 and the PLC 3.

The MES 2 and the PLC 3 update the progress status of work according to this notice (S211) and report it to the production plan management section 1. The production plan management section 1 judges according to the report whether or not the work is delayed (S212) and updates the production plan on the basis of the result thereof (S213). The production plan management section 1 notifies the updated production plan to the MES 2 and the PLC 3. The MES 2 and the PLC 3 prepare for update of the production plan (S214) and notify the update result to the work management apparatus 100. The plan update mentioned here is equivalent, for example, to stopping subsequent processing such as monitoring work as a result of completion of work processes. The work management apparatus 100 ends the measurement (S215).

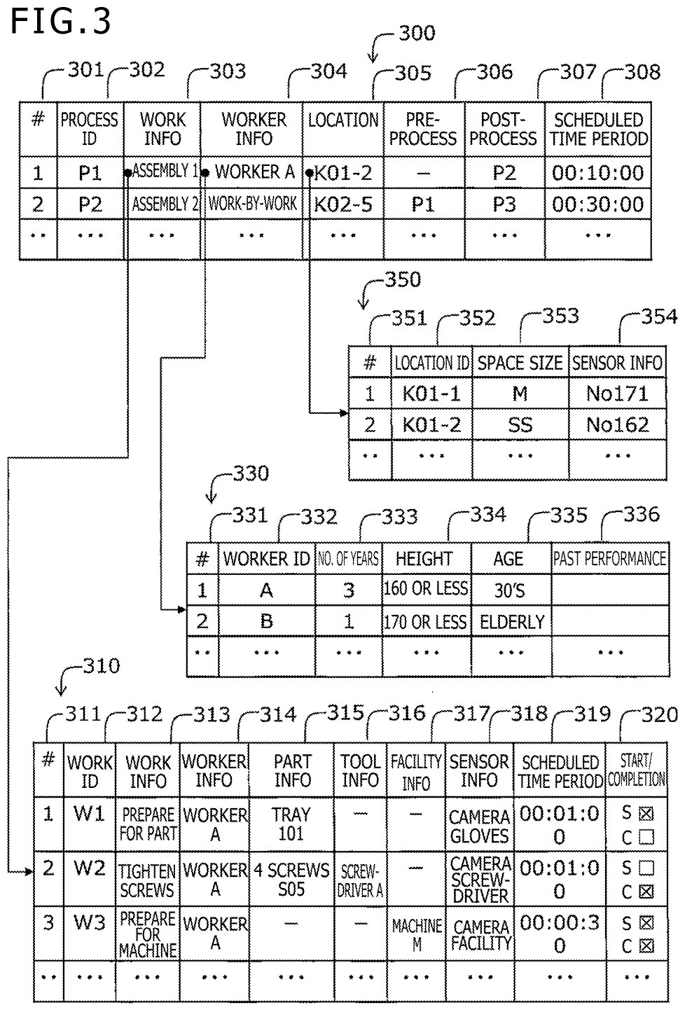

FIG. 3 illustrates an example of a work instruction 300 received by the work management apparatus 100 in S204. The work instruction 300 contains, for each work process number 301, a process identification (ID) 302, work information 303, worker information 304, a location 305, a pre-process 306, a post-process 307, a scheduled time period 308, and the like. One work process includes one or more work items. The work information 303 is linked to a work item table 310 that contains the work items. The worker information 304 is linked to a worker table 330. The location 305 is linked to a location table 350. Each table can be configured as part of a work instruction or may be stored in the storage section 30 in advance and be referred to by the control section 101 as appropriate.

The work item table 310 contains work items included in the work process, for each work item number 311. In FIG. 3, work items included in the work information 303 of “ASSEMBLY 1” are exemplified. The work item table 310 contains, for each work item number 311, a work ID 312, work information 313, worker information 314, part information 315, tool information 316, facility information 317, sensor information 318, a scheduled time period 319, start/completion 320, and the like. The start/completion 320 indicates whether or not it is necessary to report a start time and a completion time to a superordinate system (e.g., MES 2). In the case where it is checked, it is necessary to make a report.

The worker table 330 contains, for each worker number 331, a worker ID 332, the number of years 333, a height 334, an age 335, past performance 336, and the like. The past performance 336 includes information such as an actual time period as opposed to a scheduled time period, a cumulative time period, the number of defects, start/completion information acquisition accuracy, and the like regarding all processes and work performed until now by the worker or one or more pieces of work included in the work information 303 (“ASSEMBLY 1” in FIG. 3). The location table 350 contains, for each location number 351, a location ID 352, a space size 353, sensor information 354, and the like. The sensor information 354 includes attribute information of one or more sensors installed at a workplace such as identification ID, a model, a model number, an operation condition, and the like.

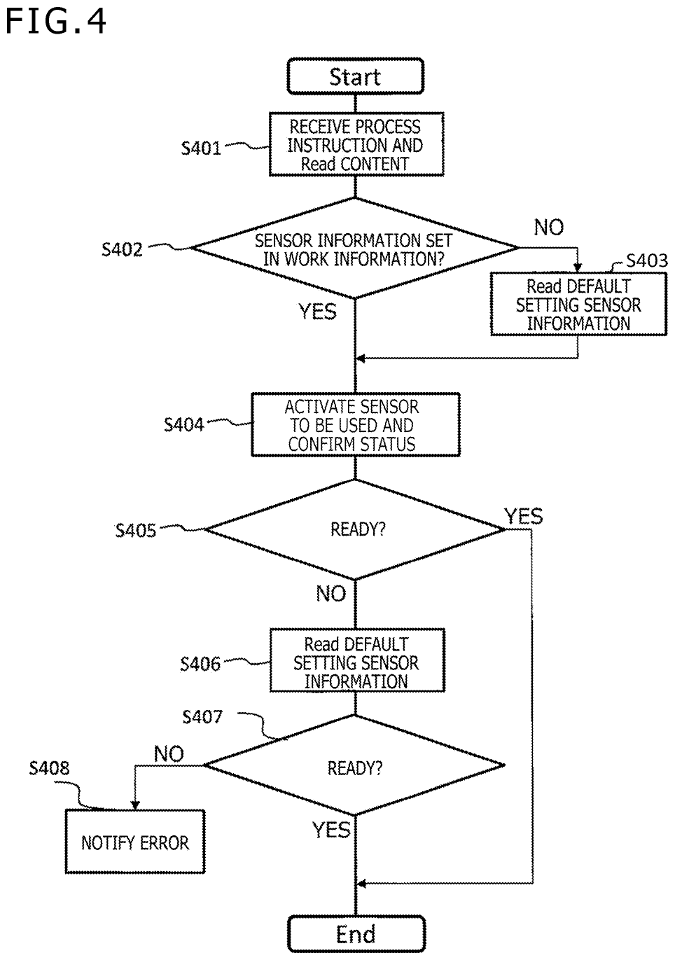

FIG. 4 is a flowchart describing a procedure for the control section 101 to send a sensor switching instruction. The control section 101 receives a work instruction from the superordinate system (e.g., MES 2) and reads the content thereof (S401). The control section 101 judges whether or not the sensor information 318 is set in the work information 303 (i.e., work item table 310) (whether or not a sensor to be used for monitoring work is specified) (S402). If not, the control section 101 acquires default setting sensor information (S403). At that time, the control section 101 specifies necessary information regarding the sensor to the worker via the display section 14 or the microphone/speaker 16 (e.g., in the case where the garment-type sensor 11 or the glove-type sensor 12 is used, the control section 101 instructs the worker to put on the sensor). The sensor switching section 103 activates the sensor to be used for monitoring work that has been determined from the above steps, and confirms the sensor status (S404). If the sensor is not ready (S405: NO), the sensor switching section 103 activates the default setting sensor in a similar manner and confirms the status (S406 and S407). If the default setting sensor cannot be made ready, the sensor switching section 103 notifies an error (S408). If any one of the sensors can be activated, the present flowchart is ended.

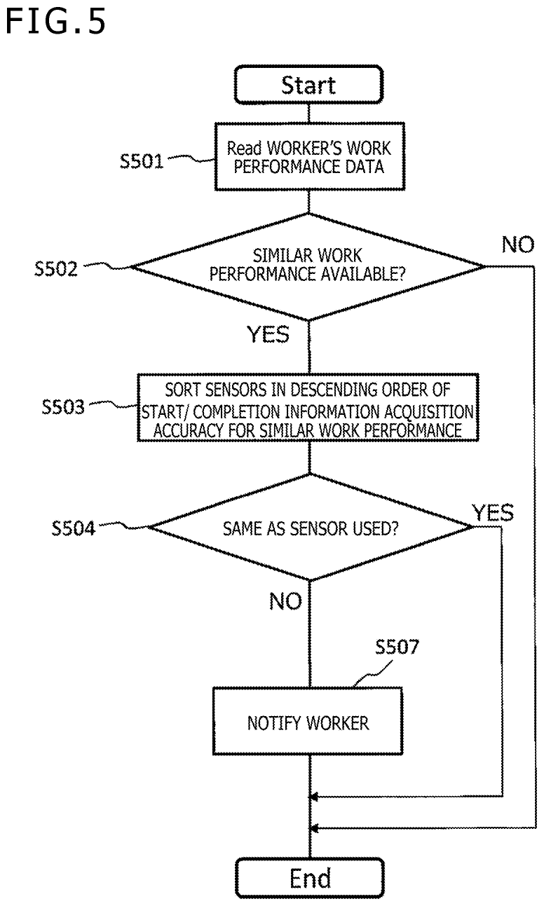

FIG. 5 is a flowchart describing a procedure for the control section 101 to determine a sensor to be used for monitoring work. Depending on the worker, there is a possibility that the content of work cannot accurately be recognized with a sensor that is normally used due, for example, to a worker's specific way of using the tool or facility or the like. It is probably desirable that, for such a worker, the sensor used in past performance in which the content of work of the worker was able to accurately be recognized should be used. The present flowchart is an example of a method of determining a sensor in such a case. Which of FIGS. 4 and 5 should be used, for example, may be specified in the work instruction, or which of the two should be used may be determined in advance for each worker.

The control section 101 reads the past performance 336 from the worker table 330 for the worker to whom a work instruction is given (S501). In the case where there is a past performance of performing similar work (S502: YES), the control section 101 sorts the sensors in descending order of start/completion information acquisition accuracy in the past work performance (S503). The control section 101 judges whether or not each sensor with the acquisition accuracy equal to or higher than a required value is the same as the sensor specified by the work instruction (S504). If the sensor specified by the work instruction and the sensor used in the past performance are the same, the sensor specified by the work instruction is used as is (S504: YES). In the case where the sensor specified by the work instruction is not included among the sensors used in the past performance, the worker is notified to that effect (S507). After notifying the worker, it is possible to optionally determine whether to use the sensor in the past performance or the sensor specified in the work instruction.

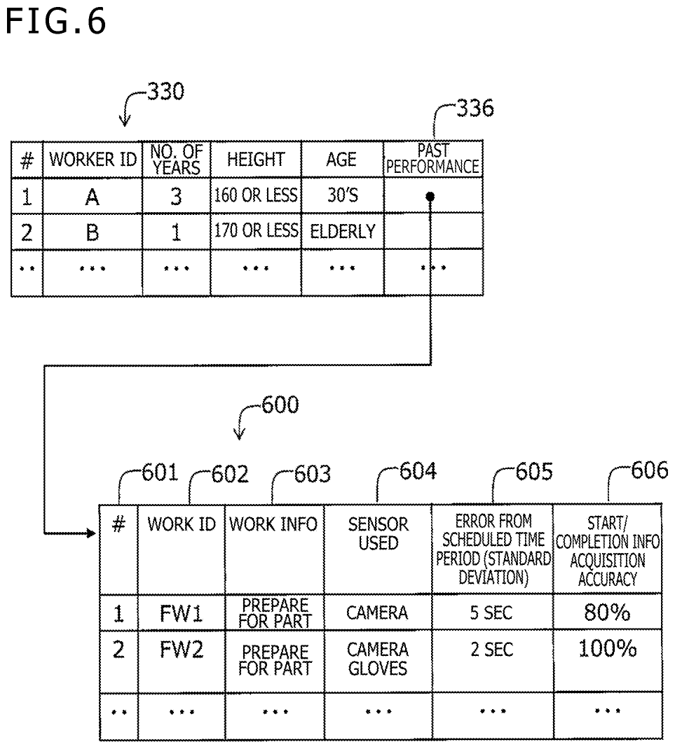

FIG. 6 is an example of the past performance 336 acquired in S501. The past performance 336 is linked to a performance table 600. The performance table 600 contains, for each work number 601, a work ID 602, work information 603, a sensor used 604, an error from scheduled time period 605, start/completion information acquisition accuracy 606, and the like. The sensor used 604 is the sensor used for monitoring work in the past work. In S503, it is only necessary to sort the sensors by the start/completion information acquisition accuracy 606.

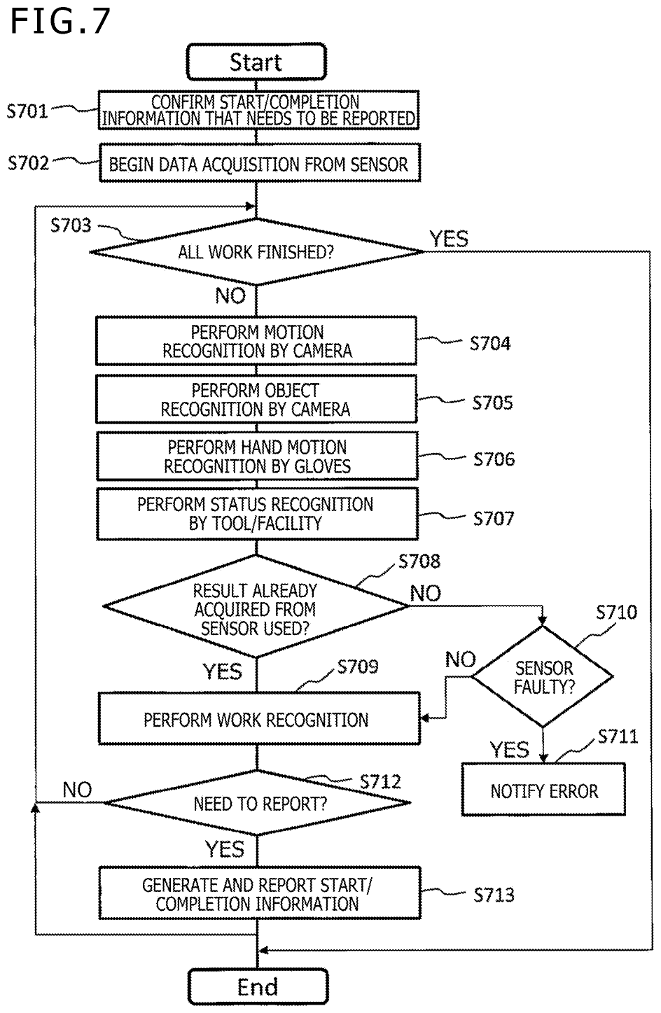

FIG. 7 is a flowchart describing a procedure until the start/completion judgment section 112 extracts start and completion times. The start/completion judgment section 112 extracts the start and completion times from the content of work recognized by the work recognition section 111. The start/completion judgment section 112 identifies, in advance, start/completion information that needs to be reported to the superordinate system, according to the start/completion 320 in the work item table 310 (S701). The video image acquisition section 104 and the data acquisition section 105 begin to acquire detection result data from each sensor (S702). The following is repeated until all the work ends (S703). The object recognition section 106 (S705), the motion recognition section 108 (S704), the hand motion recognition section 109 (S706), and the status recognition section 110 (S707) perform their recognition processing. In the case where a detection result has successfully been acquired from the sensor used (S708: YES), the work recognition section 111 recognizes the content of work (S709). In the case where a detection result has not successfully been acquired from the sensor used (S708: NO), the start/completion judgment section 112 judges whether or not the sensor is faulty (S710), and if the sensor is faulty, the error is notified (S711), and the present flowchart is ended. When the sensor is not faulty, S709 is performed by using other sensor or using only the detection result that has successfully been acquired. As for start/completion information that needs to be reported (information which has been judged in S701), the start/completion judgment section 112 generates start/completion information on the basis of the recognition result of the work recognition section 111 and reports the information (S713).

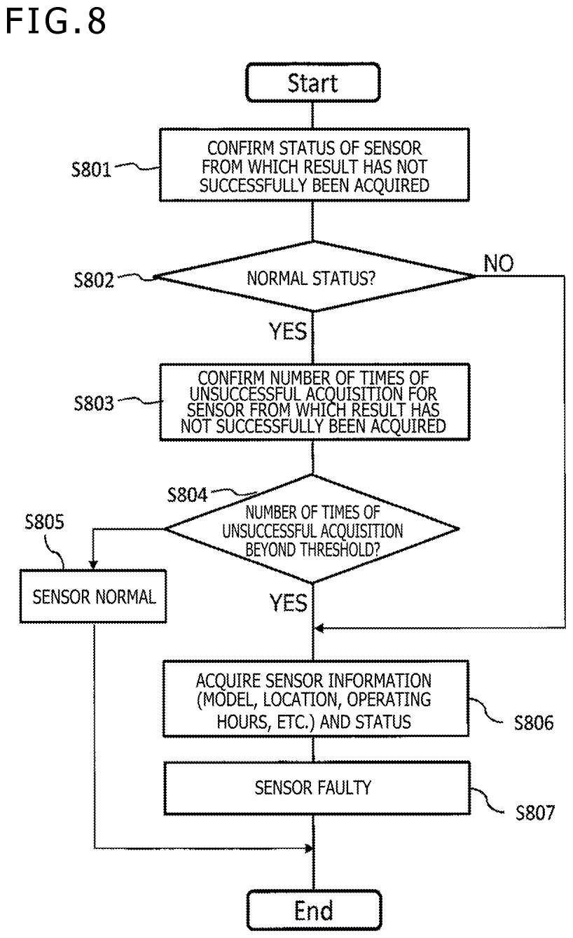

FIG. 8 is a flowchart describing details of S710. The control section 101 confirms the status of the sensor from which a detection result has not successfully been acquired (S801). If the sensor is in a normal status (S802: YES), the control section 101 confirms the number of times of unsuccessful acquisition for the sensor from which a detection result has not successfully been acquired (number of times a sensor result is not successfully acquired) (S803). In the case where the number of times of unsuccessful acquisition exceeds a threshold (S804: YES), the control section 101 acquires attribute information and the status of the sensor (S806) and judges that the sensor is faulty (S807). That is, even if the sensor is judged to be in a normal status in S802, the sensor is judged to be faulty if the number of times of unsuccessful acquisition exceeds the threshold. If the number of times of unsuccessful acquisition is equal to or less than the threshold, the sensor is judged to be in a normal status (S805). In the case where the sensor is judged to be faulty in S802, S803 to S805 are skipped, and S806 and S807 are performed.

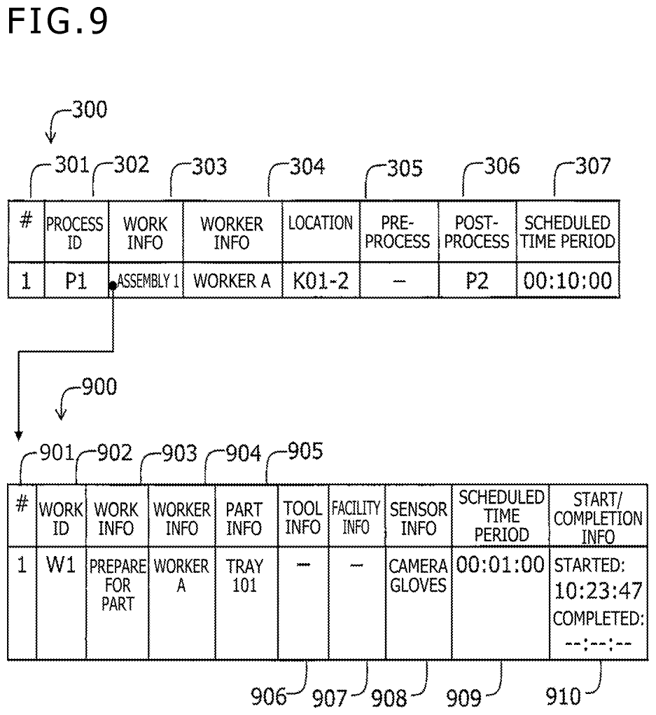

FIG. 9 is an example of start/completion information 900 output by the start/completion judgment section 112 in S208. The start/completion information 900 is linked to the work information 303 and created for each work item number 901. The start/completion information 900 has, for each work item number 901, a work ID 902, work information 903, worker information 904, part information 905, tool information 906, facility information 907, sensor information 908, a scheduled time period 909, and start/completion information 910. The configuration of the start/completion information 900 is the same as that of the work item table 310.

### Embodiment 1: Conclusion

In the work management apparatus 100 according to embodiment 1, each of the plurality of types of sensors recognizes the content of work of the worker, and the work recognition section 111 integrates the detection results, so that the work management apparatus 100 comprehensively recognizes the content of work. This makes it possible, even in the case where work including various motions or a wide variety of work conditions such as travel from one workplace to another occurs, to acquire the start and completion times of work accurately.

The work management apparatus 100 according to the present embodiment 1 installs in advance or prepares the plurality of types of sensors in a work environment and switches, according to the work instruction, between the sensors used for monitoring work. This makes it possible, for example, to quickly put in place a sensor suited for monitoring each piece of content of work even in the work environment where the content of work frequently changes due to high-mix low-volume production and the like.

### Embodiment 2

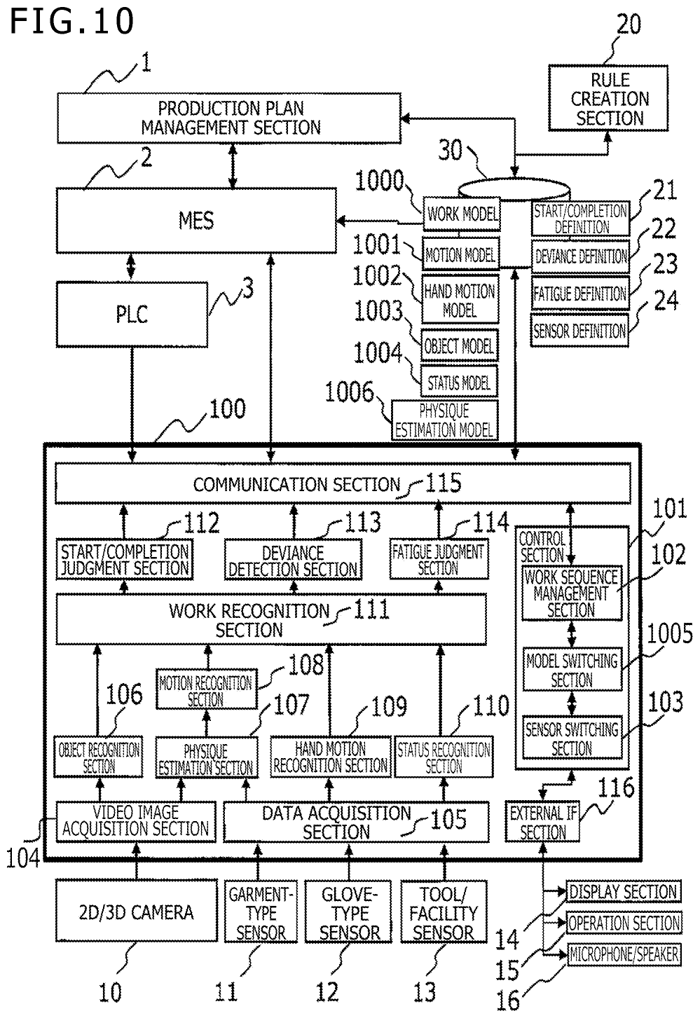

FIG. 10 is a configuration diagram of a work management system according to embodiment 2 of the present invention. In addition to the configuration described in embodiment 1, the storage section 30 stores a work model 1000, a motion model 1001, a hand motion model 1002, an object model 1003, a status model 1004, and a physique estimation model 1006. These are data that prescribes recognition processing performed by each of the work recognition section 111, the motion recognition section 108, the hand motion recognition section 109, the object recognition section 106, and the status recognition section 110. The configuration of model data varies depending on the content of recognition processing.

The work management apparatus 100 includes a model switching section 1005 in addition to the configuration described in embodiment 1. The model switching section 1005 switches between the models used by each recognition section. The storage section 30 may store, in advance, a plurality of types (or a plurality of versions) of models for each recognition section.

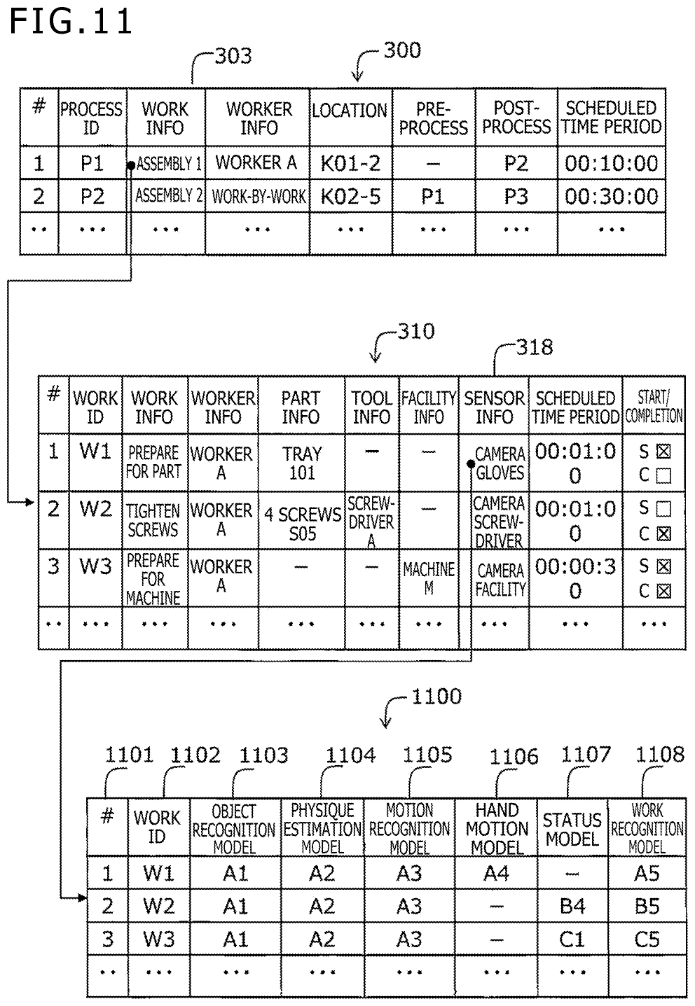

FIG. 11 illustrates a configuration of a model table 1100 and examples of data. The model table 1100 defines, for each work item, a recognition model used by each recognition section. The model table 1100 can be stored in the storage section 30 in advance. The model table 1100 contains, for each work item number 1101, a work ID 1102, an object recognition model 1103, a physique estimation model 1104, a motion recognition model 1105, a hand motion model 1106, a status model 1107, and a work recognition model 1108. The model switching section 1005 reads a record of the model table 1100 corresponding to the work item specified by the work instruction and instructs each recognition section to use the recognition model specified by that record. Here, although one model used by each recognition section is set in the model table 1100 of FIG. 11, a model may be set for each sensor used. For example, in the case where the 2D/3D camera 10 and the garment-type sensor 11 are used, the physique estimation section 107 can set a different model for each sensor, namely, a model A2-1 for a video image of the 2D/3D camera 10 and a model A2-2 for the garment-type sensor 11.

The model table 1100 contains, in addition to the fields illustrated in FIG. 11, a data size and a storage destination of each model (e.g., address and file path of a storage device included in the work management apparatus 100). Usages thereof will be described later.

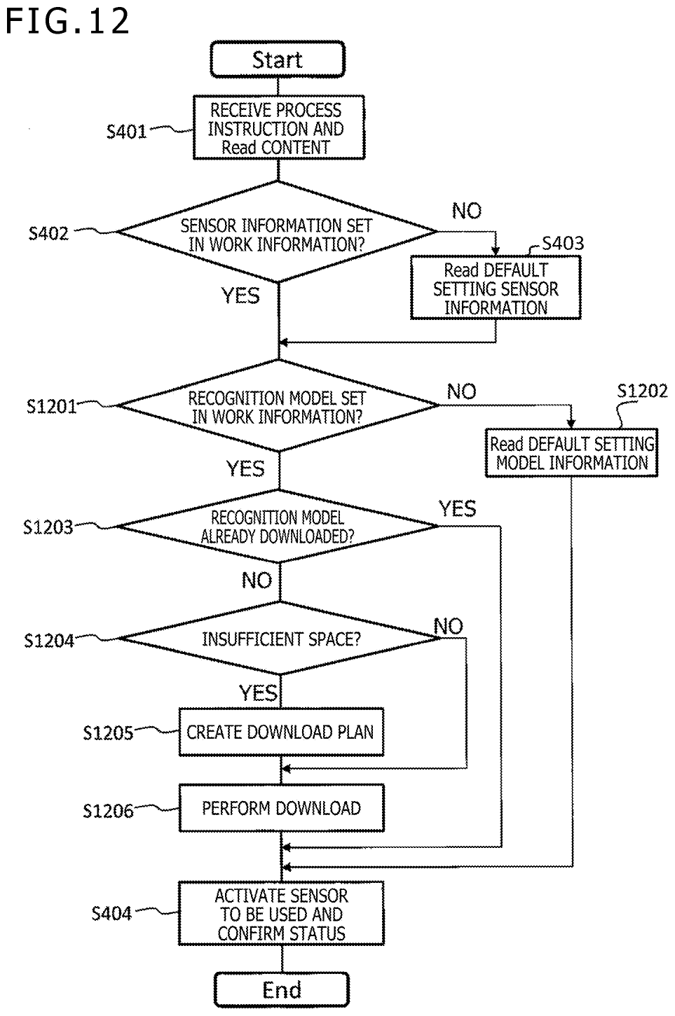

FIG. 12 is a flowchart describing a procedure for the control section 101 to switch between recognition models. The present flowchart can be performed in combination with the flowchart described in FIG. 4. In consequence, some steps are the same as those in FIG. 4, and the same step numbers as in FIG. 4 are assigned to the common steps. A description will be given below of the steps specific to FIG. 12.

In the case where a recognition model (corresponding record in the model table 1100) is not set in the work information 303 (S1201: NO), the control section 101 reads default setting recognition model information (S1202). In the case where a recognition model is set in the work information 303 (S1201: YES), the control section 101 judges whether or not each recognition section has already downloaded that recognition model (already acquired it from the storage section 30) (S1203). If the recognition model has yet to be acquired, the control section 101 further judges whether or not there is sufficient free space to acquire a new recognition model in the storage device on the work management apparatus 100 (S1204). If there is sufficient free space, the control section 101 performs a download immediately (S1206), and if there is not sufficient free space, the control section 101 first creates such a download plan as to perform a download while at the same time avoiding lack of space (S1205), and proceeds with a download (S1206).

The download plan may be configured, for example, in such a manner that the recognition models are acquired from the storage section 30 in order from those that can be acquired within the bounds of free space. The model switching section 1005 instructs each recognition section to use the acquired recognition models. Alternatively, the recognition models may automatically be switched from one to another by overwriting the previous recognition model with a new recognition model. It should be noted, however, that, because the recognition model used by each recognition section is prescribed for each work item, it is desirable that model switching be performed synchronously by the respective recognition sections in such a manner that the recognition model to be used for that work item is used by the respective recognition sections at the same time. In consequence, it is desirable that the model switching section 1005 instruct the respective recognition sections to perform model switching in such a manner that the model switching is synchronized among the recognition sections.

### Embodiment 3

In embodiment 3 of the present invention, a description will be given of a configuration example in which, in the case where the start and completion times identified by the start/completion judgment section 112 are lost, the loss is identified and complemented, after which a report is made to the superordinate system. The configuration of the work management system is similar to that of embodiments 1 and 2.

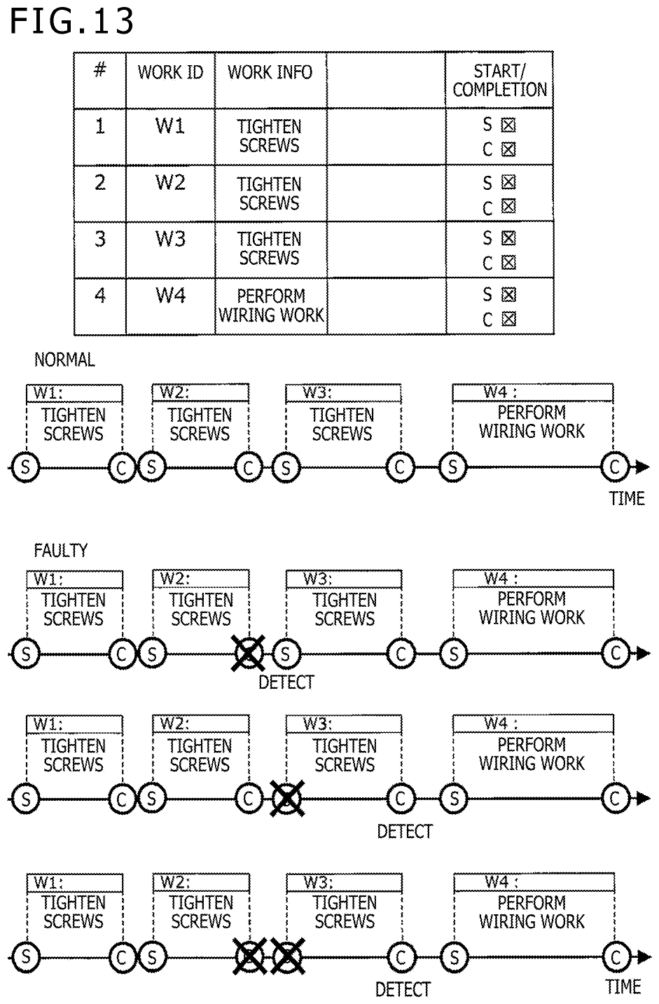

FIG. 13 illustrates examples of work items whose start and completion times are lost. Depending on the content of work identified by the work recognition section 111, there are cases where the start/completion judgment section 112 cannot identify either one of or both of the start and completion times. A description will be given here of a procedure for identifying and complementing a loss by taking, as an example, a process that includes, as work items, three pieces of screw tightening work W1 to W3 followed by wiring work W4.

The start/completion judgment section 112 judges that a completion time is lost, in the case where two consecutive start times are recognized without recognizing a completion time (first faulty example in FIG. 13). The start/completion judgment section 112 complements the lost completion time by a time at or before the second start time. For example, it is only necessary to copy the second start time as the lost completion time. Alternatively, a time slightly earlier than that may be used as the completion time.

The start/completion judgment section 112 judges that a start time is lost, in the case where two consecutive completion times are recognized without recognizing a start time (second faulty example in FIG. 13). The start/completion judgment section 112 complements the lost start time by a time at or before the second completion time. For example, it is only necessary to copy the second completion time as the lost start time. Alternatively, a time slightly earlier than that may be used as the start time.

The start/completion judgment section 112 judges that one of the start and completion times is lost or has a discrepancy, in the case where there is a significant difference in time length of work between similar pieces of work (faulty example not illustrated in FIG. 13). For example, if the difference in time length of work between work items is equal to or larger than a threshold, one of the start and completion times for the work item with a longer time length is complemented. The start/completion judgment section 112 similarly judges that one of the start and completion times is lost or has a discrepancy, in the case where an interval between work items is shorter than other intervals by a threshold or more. The start/completion judgment section 112 substitutes a next start time for a lost completion time in the case where a completion time is lost, and substitutes a next completion time for a lost start time in the case where a start time is lost.

The start/completion judgment section 112 can recognize that a completion time and a start time are consecutively lost, by acquiring a work time period definition or a work order definition of similar work from the work instruction 300 and comparing this with extraction results of the start and completion times (third faulty example in FIG. 13). For example, if there is a work item that is longer than similar work by a threshold or more, such a loss can be detected. The start/completion judgment section 112 can substitute a succeeding completion time or a previous start time of the lost start and completion times for the lost start and completion times. For example, the start time of W2 is substituted for the completion time of W2, and the completion time of W3 is substituted for the start time of W3.

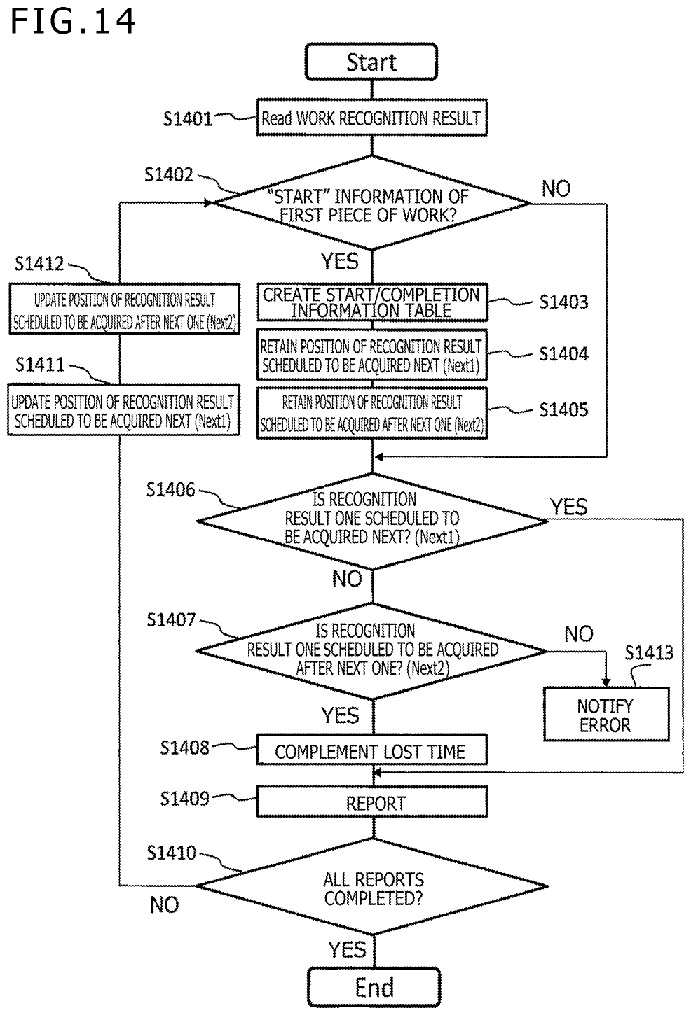

FIG. 14 is a flowchart describing a procedure for the start/completion judgment section 112 to complement the start and completion times. The start/completion judgment section 112 reads a recognition result of the work recognition section 111 (S1401). In the case where a start time of a first piece of work is read, the start/completion judgment section 112 creates the start/completion information 900 (S1403) and next grasps, in advance, a position of a start and completion recognition result scheduled to be acquired next and a position of a start and completion recognition result scheduled to be acquired after the next one (grasps, in advance, which of the start time and the completion time is scheduled to be acquired for the next work item) (S1404 and S1405). The start/completion judgment section 112 records, if a recognition result is one scheduled to be acquired next (S1406: YES), that recognition result for reporting purposes (S1409). Even if the recognition result is not the one scheduled to be acquired next (S1406: NO), the start/completion judgment section 112 judges whether or not the recognition result is one scheduled to be acquired after the next one (S1407). This corresponds to acquiring the time scheduled to be acquired after the next one if one of the start and completion times is lost. If the recognition result is not the one scheduled to be acquired after the next one, either, an error is recorded (S1413), and the present flowchart is ended. If the recognition result is the one scheduled to be acquired after the next one, the lost time is complemented (S1408), after which the recognition result is recorded for reporting purposes” (S1409). A similar procedure (S1411, S1412, and S1406 to S1409) is repeated for all the start and completion times that need to be reported.

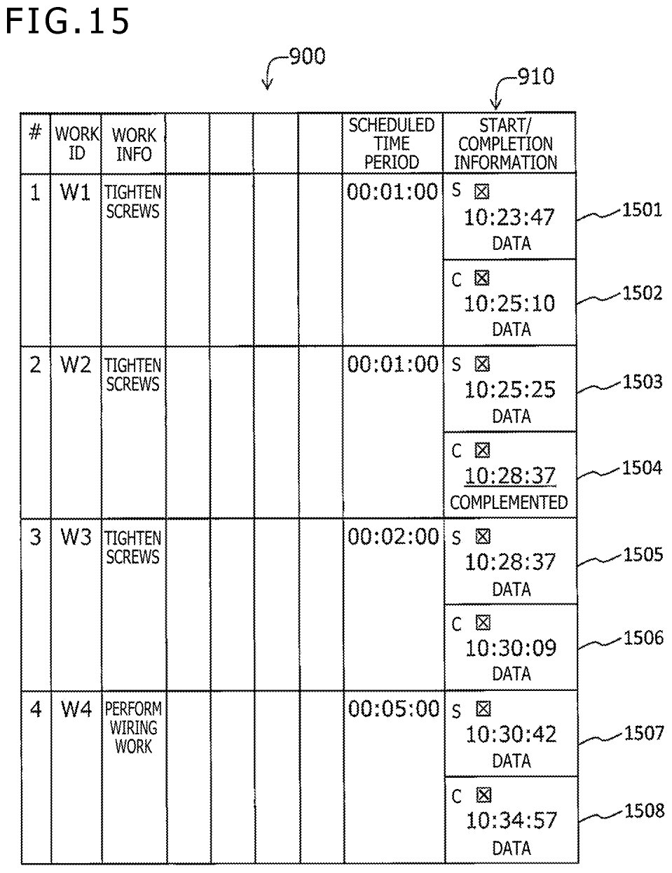

FIG. 15 is an example of the start/completion information 900 in which the start and completion times have been complemented. It is illustrated that, of start/completion times 1501 to 1508, the completion time 1504 has been complemented by copying the start time 1505. Thus, by making a report to the superordinate system without losing any of the start and completion times, it is possible for the superordinate system to at least formally continue the work processes without stopping them.

### Modification Examples of the Present Invention

The present invention is not limited to the above embodiments and includes various modification examples. For example, the above embodiments have been described in detail to describe the present invention in an easy-to-understand manner and are not necessarily limited to those that include all the components described above. Also, some of the components of one embodiment can be replaced by components of another embodiment, and components of one embodiment can be added to components of another embodiment. Further, it is possible to add other components to some components of each of the embodiments and remove or replace some components thereof.

In the above embodiments, the work sequence management section 102, the sensor switching section 103, and the model switching section 1005 may be configured as part of the control section 101 or configured as functional sections separate from the control section 101.

In the above embodiments, each of the functional sections included in the work management apparatus 100 can be configured by hardware such as a circuit device in which that function is implemented, or can be configured by an arithmetic device such as a central processing unit (CPU) executing software having that function implemented therein.

Although an example has been described in which work in production processes is managed in the above embodiments, the present invention can similarly be applied to a case where other work is managed. That is, the present invention is applicable as long as the content of work of a worker is recognized by using various sensors and start and completion times and losses thereof are identified by using the recognition results.

What is claimed is:

1. A work management apparatus for managing work performed by a worker, comprising:
a motion recognition section configured to recognize a motion of the worker by using a measurement result of a sensor;
an object recognition section configured to recognize, by using the measurement result of the sensor or data acquired from an object used by the worker, an operation status of the object;
a work recognition section configured to recognize content of work of the worker by using a recognition result of each of the motion recognition section and the object recognition section;
a control section configured to control the motion recognition section, the object recognition section, and the work recognition section; and
a start/completion judgment section configured to identify a start time at which the worker has started the work and a completion time at which the worker has completed the work, according to the content of the work identified by the work recognition section, wherein
the control section confirms whether or not there is any missing content of the work on a basis of the start time identified by the start/completion judgment section and the completion time identified by the start/completion judgment section and outputs a confirmation result thereof.

2. The work management apparatus according to claim 1, wherein,
in a case where at least one of the start time identified by the start/completion judgment section and the completion time identified by the start/completion judgment section is lost, the control section complements the lost time, and
the control section writes and outputs the complemented time as part of the confirmation result.

3. The work management apparatus according to claim 2, wherein
the control section acquires the start time and the completion time for each of content of work for a first work process and content of work for a second work process that follows the first work process, and
in a case where the start time of the first work process is acquired, the completion time of the first work process is lost, and then the start time of the second work process is acquired, the control section complements the lost completion time of the first work process.

4. The work management apparatus according to claim 2, wherein
the control section acquires the start time and the completion time for each of content of work for a first work process and content of work for a second work process that follows the first work process, and
in a case where the completion time of the first work process is acquired, the start time of the second work process is lost, and then the completion time of the second work process is acquired, the control section complements the lost start time of the second work process.

5. The work management apparatus according to claim 2, wherein
the control section acquires the start time and the completion time for each of content of work for a first work process and content of work for a second work process that follows the first work process,
in a case where the completion time of the first work process is lost, the control section complements the lost completion time of the first work process in such a manner that the completion time of the first work process is equal to or earlier than the start time of the second work process, and
in a case where the start time of the second work process is lost, the control section complements the lost start time of the second work process in such a manner that the completion time of the first work process is equal to or earlier than the start time of the second work process.

6. The work management apparatus according to claim 2, wherein
the control section acquires the start time and the completion time for each of content of work for a first work process and content of work for a second work process that is similar in type to the first work process and follows the first work process,
the control section calculates a first time length of the first work process on a basis of the start time and the completion time of the first work process,
the control section calculates a second time length of the second work process on a basis of the start time and the completion time of the second work process, and
in a case where a difference between the first time length and the second time length is equal to or larger than a threshold, the control section complements at least one of the start time and the completion time for whichever is longer of the first work process and the second work process.

7. The work management apparatus according to claim 6, wherein,
in a case where the difference between the first time length and the second time length is equal to or larger than the threshold, the control section complements a loss by substituting the start time of a next process for the lost completion time or by substituting the completion time of the next process for the lost start time, for whichever is longer of the first work process and the second work process.

8. The work management apparatus according to claim 2, wherein
the control section acquires an order of the content of the work, and
the control section judges whether or not both the start time identified by the start/completion judgment section and the completion time identified by the start/completion judgment section are lost, by comparing the content of the work recognized by the work recognition section with the order.

9. The work management apparatus according to claim 1, further comprising:
a sensor switching section configured to output a sensor switching instruction for switching a type of the sensor, wherein
the control section acquires a work instruction for the worker, and
the sensor switching section configures the sensor switching instruction according to the work instruction.

10. The work management apparatus according to claim 9, wherein,
in a case where the sensor type is specified by the work instruction, the sensor switching section configures the sensor switching instruction according to the specification, and
in a case where the sensor type is not specified by the work instruction, the sensor switching section configures the sensor switching instruction in such a manner that a default sensor is specified.

11. The work management apparatus according to claim 10, wherein
the sensor switching section acquires a past work history of the worker, and
in a case where there is, among sensors used in the work history, a past sensor for which a rate of accurate acquisition of the start time and the completion time by the start/completion judgment section is equal to or larger than a reference value, the sensor switching section configures the sensor switching instruction in such a manner that the past sensor is used instead of a sensor of the type specified by the work instruction.

12. The work management apparatus according to claim 1, further comprising:
a model switching section configured to output a model switching instruction for switching recognition models that prescribe respective pieces of recognition processing performed by the motion recognition section, the object recognition section, and the work recognition section, wherein
the control section acquires a work instruction for the worker, and
in a case where a type of the sensor is specified by the work instruction, the model switching section configures the model switching instruction in such a manner that the recognition model corresponding to the sensor type is used.

13. The work management apparatus according to claim 12, wherein
the model switching section creates a schedule for performing the model switching instruction, in such a manner that the recognition models are switched synchronously between the motion recognition section, the object recognition section, and the work recognition section.

14. The work management apparatus according to claim 12, wherein,
when a new recognition model is acquired according to the model switching instruction, the model switching section creates a schedule for performing processing of acquiring the new recognition model so as to ensure that there is no lack of free space in a storage device for storing the recognition model.
